(19) United States
(12) Patent Application Publication
(10) Pub. No.: US 2016/0142684 A1
(43) Pub. Date: May 19, 2016

(54) CAMERA APPARATUS AND METHOD

(71) Applicant: Robert Gruder, Charlotte, NC (US)

(72) Inventor: Robert Gruder, Charlotte, NC (US)

(21) Appl. No.: 14/749,137

(22) Filed: Jun. 24, 2015

Related U.S. Application Data
(60) Provisional application No. 62/080,271, filed on Nov. 15, 2014.

(51) Int. Cl. H04N 7/18; H04N 5/77; H04N 5/225

(52) U.S. Cl. CPC H04N 7/185; H04N 5/2251; H04N 5/77

(57) ABSTRACT

A camera apparatus and method is disclosed. The camera apparatus includes an image sensor operable to generate image data; a storage device operable to store the image data from the image sensor; and a controller operably connected to the image sensor and the storage device. The controller is programmed to receive the image data and transfer the image data to the storage device in a recording loop of a predetermined duration. The controller is programmed to respond to a privacy command received from a user during the recording loop by pausing the transfer of image data to the storage device for a predetermined pause interval.

### BACKGROUND OF THE INVENTION

The present invention relates generally to a camera apparatus, and more particularly, the invention relates to a camera apparatus for use on a person's body.

Cameras and social media have changed the way society interacts. For example, sporting events are using helmet cameras and/or car mounted cameras to provide a viewer with an up close and more immersive view that allows the viewer to see what the athlete wearing the camera sees. Cell phone cameras are being used to record and post live events to social media.

In the last few years, we have seen the need for body cameras on law enforcement officers. Recent altercations between law enforcement officers and citizens of the area they serve have been brought to the forefront as both law enforcement officers and citizens are accused of acting inappropriately. As a result, protesting, riots, and violence has escalated due to the fact that an accurate representation of the events that took place is often unavailable. Such events have led citizens to distrust law enforcement and to hesitation by law enforcement for fear that they will be accused of acting inappropriately.

One of the issues with body cameras is that they often require a user to activate the camera by pushing a record button. In the heat of the moment, a user can often forget to push the record button, thereby eliminating any chance of recording the events as they occur. Other cameras are simply on all of the time, thereby eliminating any private time or requiring the user to actively turn the camera off and back on again. In the latter case, the user may forget to turn the camera back on.

Accordingly, there is a need for an improved camera apparatus for use on a person's body that minimizes user error and stores appropriate content.

### BRIEF SUMMARY OF THE INVENTION

This need is addressed by providing a camera apparatus and method that is easy to use, allows for privacy, and helps eliminate recording errors.

### BRIEF DESCRIPTION OF THE DRAWINGS

The subject matter that is regarded as the invention may be best understood by reference to the following description taken in conjunction with the accompanying drawing figures in which:

FIG. 1 is a front view of a camera apparatus;

FIG. 2 is a top view of the camera apparatus of FIG. 1;

FIG. 3 is a side view of the camera apparatus of FIG. 1;

FIG. 4 shows a battery pack connected to the camera apparatus of FIG. 1;

FIG. 5 is another side view of the camera apparatus of FIG. 1;

FIG. 6 is a bottom view of the camera apparatus of FIG. 1; and

FIG. 7 is a rear view of the camera apparatus of FIG. 1.

### DETAILED DESCRIPTION OF THE INVENTION

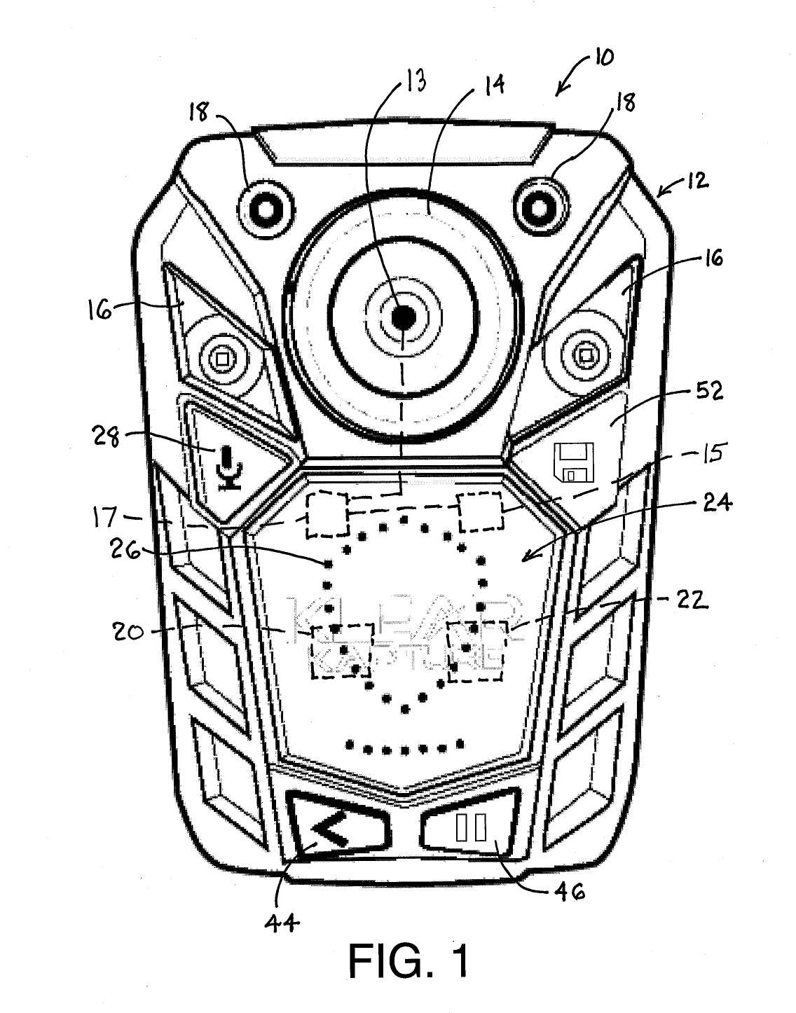

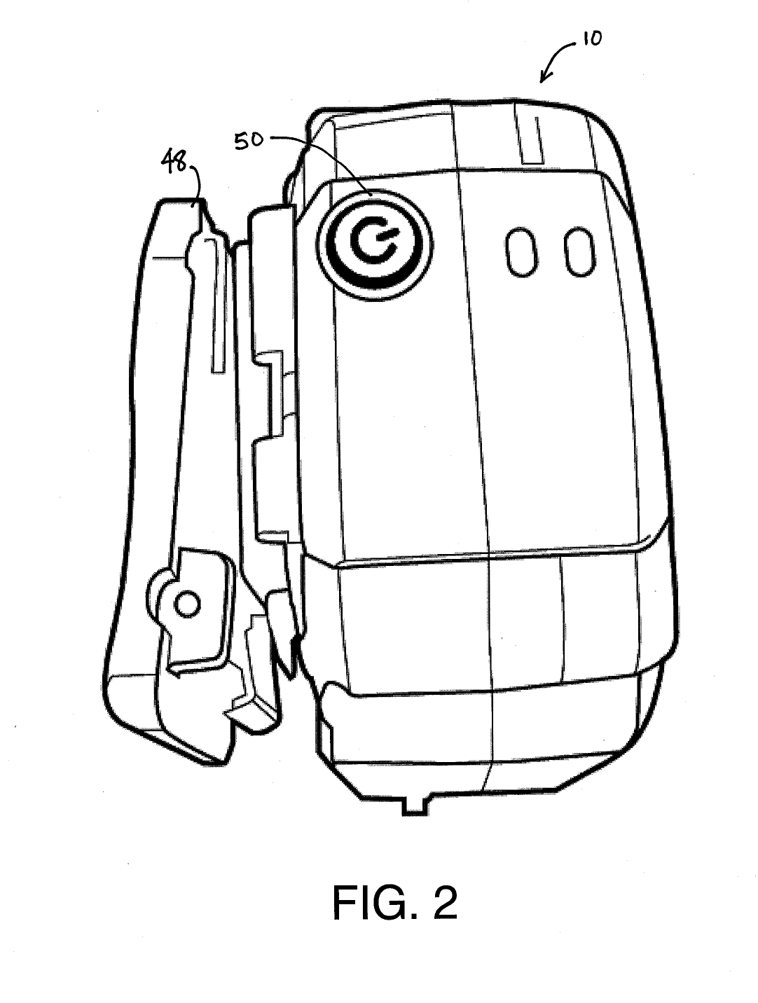

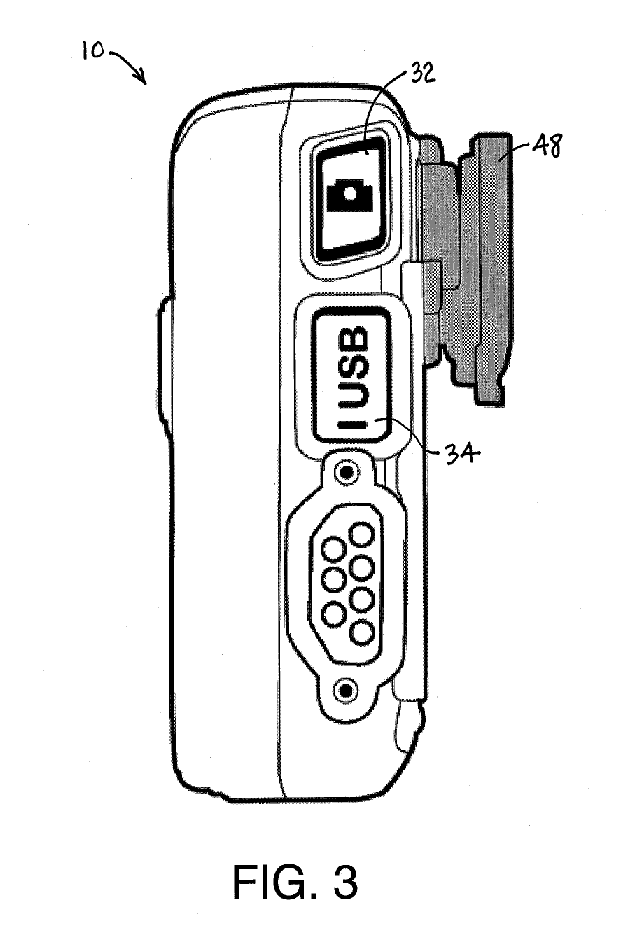

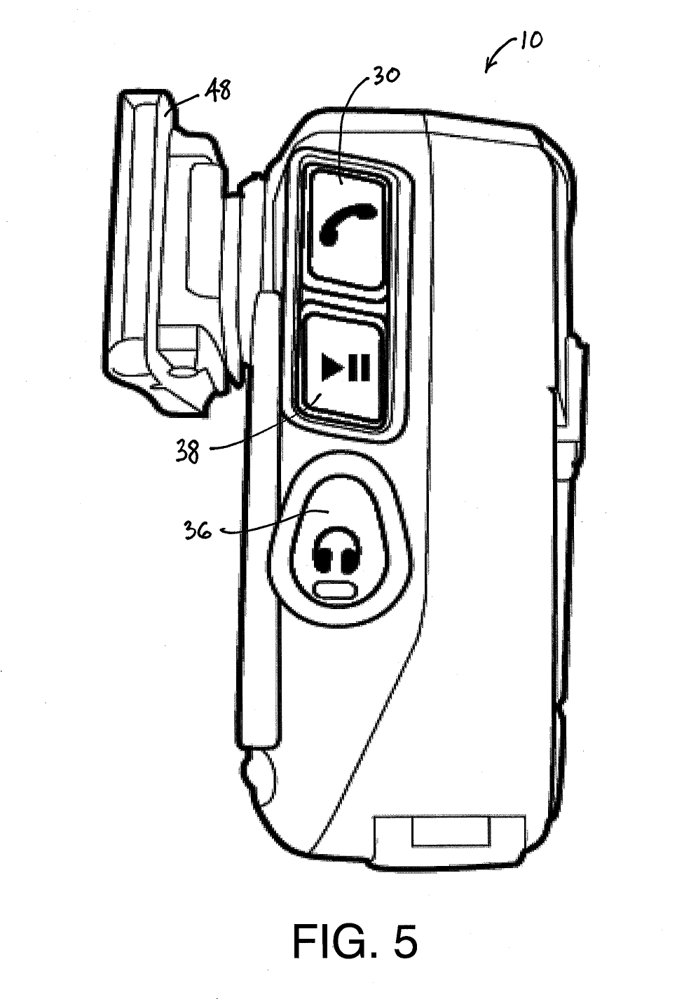

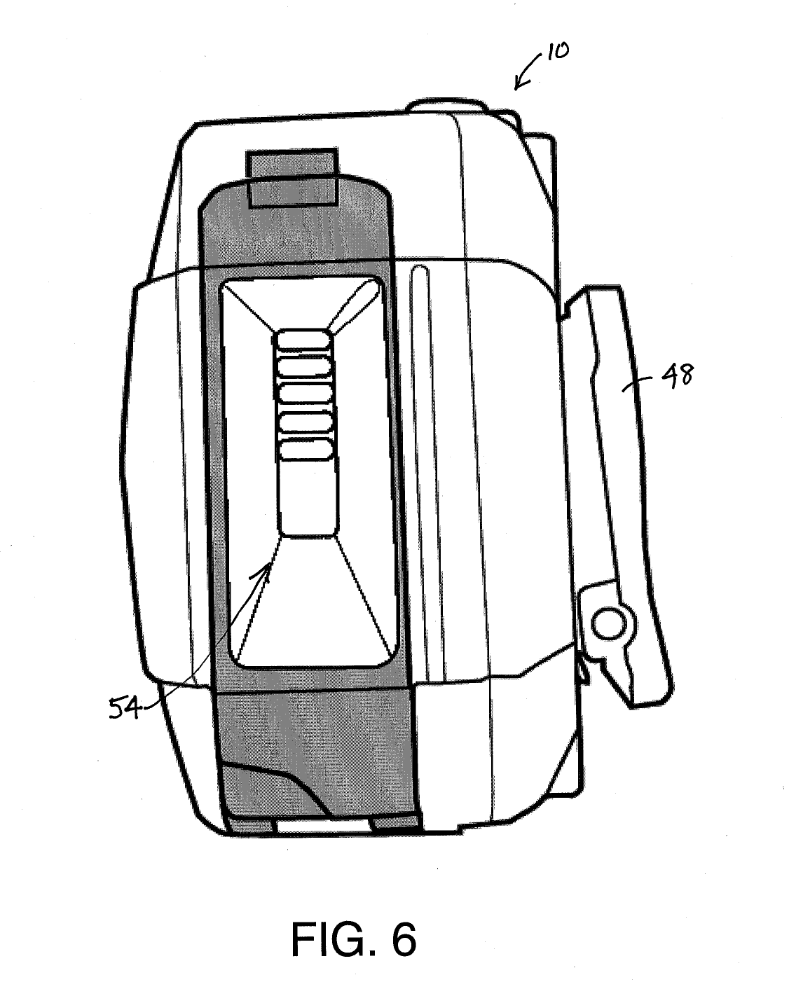

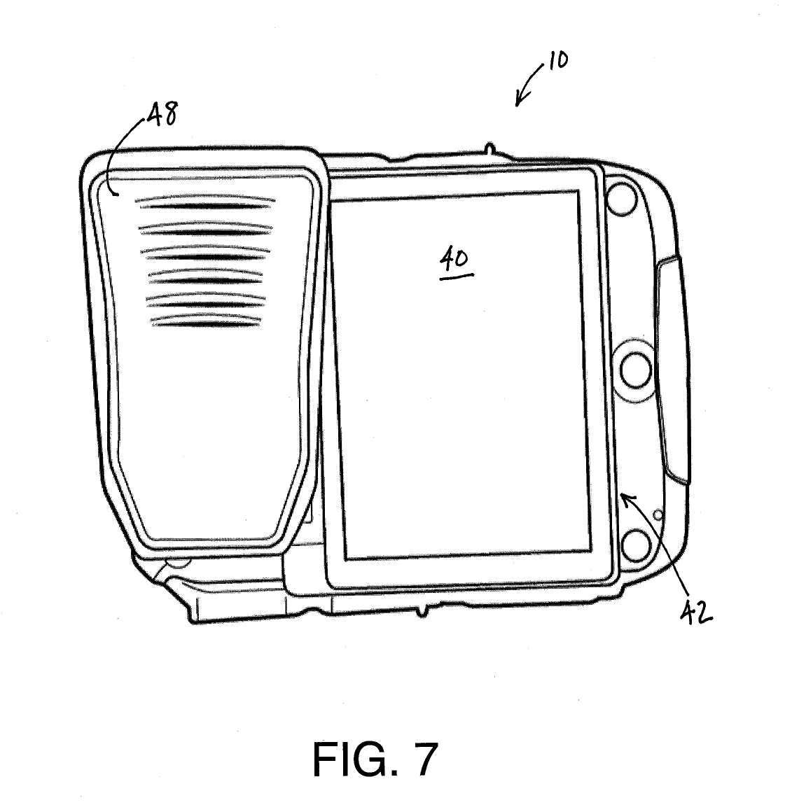

Referring now specifically to the drawings, a camera apparatus for use on a person's body is illustrated in FIGS. 1-7 and shown generally at reference numeral 10. In general, the camera apparatus 10 includes an outer housing 12 configured to house the camera apparatus' electronics (including an image sensor 13 operable to generate image data, a storage device 15 operable to store image data and audio data, and a controller 17) in a weather proof container. The image sensor 13 and storage device 15 are connected to the controller 17 to permit transmission of image data from the image sensor 13 to the storage device 15. A lens 14 is connected to the image sensor 13 and configured to focus on an image and allow the image sensor 13 to capture the image as a video and/or still image. The camera apparatus 10 may be cycled between a “playback” mode and a “use” mode. It should be appreciated that the term “image data” refers to any known type of image data such as video and photographic and/or still images.

The controller 17 may be a separate hardware device or it may be incorporated into or combined with the hardware of the image sensor 13 and/or the storage device 15. The controller 17 may be implemented as one or more software programs running on one or more processors. For example, the controller 17 could be integral to the programming of the image sensor 13. The controller 17 is configured to receive and/or respond to commands from buttons and/or switches like microphone button 28, call button 30, still image button 32, playback button 38, rewind button 44, pause button 46, power button 50, and save button 52. Each of the buttons and/or switches are described below. It should be appreciated that the controller 17 may also be responsive to wireless commands provide by external devices via radio frequency (“RF”), infrared (“IR”), short-range ultra-high frequency (“UHF”) such as BLUETOOTH, a local area network such as Wi-Fi, or a wide-area network such as the Internet.

Infrared lights 16 are provided to illuminate an area for the camera apparatus 10 at night and are activated by infrared sensors 18. A microphone 20 and speaker 22 are positioned behind a front panel 24 of the camera apparatus 10. Apertures 26 allow audible sounds to pass through the front panel 24 to the microphone 20 and out of the front panel 24 from the speaker 22 to a user. The microphone 20 receives audible sounds and/or data, such as speech, background noise, etc. and sends the audible data to the controller 17 to allow the camera apparatus 10 to record the audible data and store the audible data in the storage device 15. The microphone is turned on and off by actuating a microphone button 28.

The microphone 20 may be used in one of three modes. The first mode is an “in-use” mode where the microphone may be used in three configurations: (1) On (Microphone is on all of the time); (2) Off (Microphone is off all of the time); and (3) User Discretion (Microphone may be actuated between on and off configurations by user). The second mode is a “playback” mode. The playback mode allows a user to annotate a video or still image taken by the camera apparatus 10 during playback of the video and/or still image. In this mode, if the user wants to point out something of relevance shown in a video, the user actuates the microphone button to “on” and records a message. When done recording the message, the user actuates the microphone button to “off”; thereby, saving the recording with the video. The third mode allows a user to use the camera apparatus 10 as a walkie-talkie by actuating call button 30 to activate the microphone 20 and transmit a message over a radio frequency to another camera and/or walkie-talkie device. It should be appreciated that a call button 30 and walkie-talkie mode is an optional feature and is not paramount to the overall operation of the camera 10.

The speaker 22 allows a user to hear audible sounds recorded on a video during playback or if the camera apparatus 10 is being used as a walkie-talkie, may be used to listen to another user transmitting a message to the camera apparatus 10.

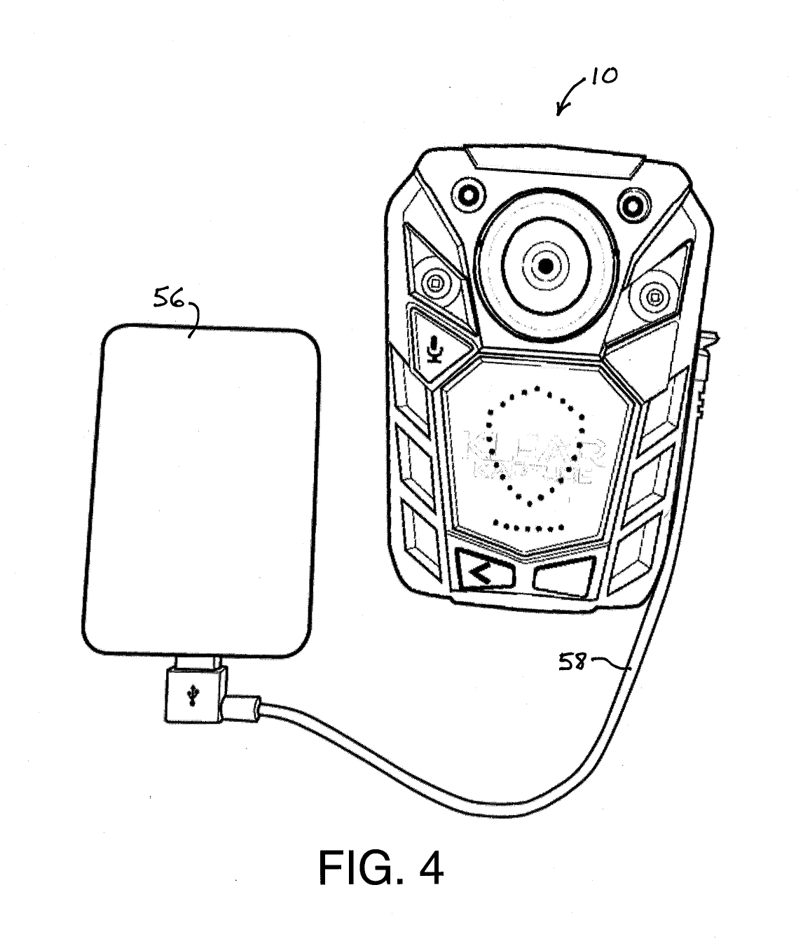

A still image button 32 is positioned on a side of the camera apparatus 10 to permit a user to snap a still image. The still image may be taken at any time whether the camera apparatus 10 is recording or not and is taken by actuating the still image button 32, thereby causing the camera apparatus 10 to take the still image. A Universal Serial Bus (USB) connection 34 is provided to allow the camera apparatus 10 to be connected to a computing device via a USB cord 58 to download still shots and video taken during use and/or to connect to a battery backup 56, as shown in FIG. 4. A charging port 54 is positioned on a bottom of the camera apparatus 10 to allow the camera apparatus 10 to be docked in a charging cradle.

A head-set port 36 is provided to allow a user to listen to recorded audio over a pair of headphones and a playback button 38 is provided to allow a user to place the camera apparatus 10 in the playback mode to playback any video and/or still shots recorded on the camera apparatus 10. A video screen 40 is positioned on a rear panel 42 of the camera apparatus 10 to permit video playback thereon and is activated in playback mode by actuating the playback button 38. The video screen 40 is connected to the controller 17 to receive image data from the storage device 15.

When in playback mode, the playback button 38 may be used to play and/or pause a recorded video. Actuating rewind button 44 causes the video to rewind until the rewind button 44 is released and actuating pause button 46 causes the video to fast forward until the pause button 46 is released.

A clip 48 is positioned on the rear panel 42 to permit the camera apparatus 10 to be attached and/or clipped onto a user's clothing, belt, and/or any other suitable support structure.

To use the camera apparatus 10, a user actuates power button 50, sending a power on command to the controller 17 to turn the camera apparatus 10 on and allowing the camera apparatus 10 to automatically go into “use” mode. Actuating the power button 50 again sends a power off command to the controller 17 to turn the camera apparatus 10 off. The user may interrupt the “use” mode by actuating playback button 38, thereby switching the camera apparatus 10 into “playback” mode.

Once the camera apparatus 10 is in “use” mode, the camera apparatus 10 may be used in one of three modes to best fit user preferences and/or usage policies. It should be appreciated that the camera apparatus 10 may be programmed to allow a user to select one of the three modes or locked out into a single mode chosen by, for example, a police department.

In the first mode, the camera apparatus 10 immediately begins recording video in a recording loop having a predetermined duration. The duration of the recording loop may be programmed based on the user preferences and/or usage policies, for example, recording loop durations may be 1, 5, 10, 15, 20, 25, 30, 35, 40, 45, 50, 55, 60, 90, 120, or continuous minutes. As used herein, the term “loop” or “recording loop” refers to a process of recording information for the predetermined duration and then overwriting the first (i.e. oldest) information with new information. This process is analogous to recording using a continuous loop of magnetic tape. When an event occurs, the event is recorded during one of the recording loop durations. When the event is over, the user actuates save button 52, thereby issuing a save command to the controller 17 to save the event on the storage device 15 and prevent the camera apparatus 10 from overwriting the event. The process of preventing data on the storage device from being overwritten may be referred to as “archiving” the data. A new recording loop is then started—the recording loop process is not interrupted when the save button 52 is actuated. Actuating the pause button 46 issues a privacy command to the controller 17 and permits the user to place the camera apparatus 10 in privacy mode; thereby, pausing the recording. Privacy mode allows the user to have a moment of privacy. For example, the user may need to go to the restroom or to have a private conversation with someone. Privacy mode is set for a predetermined pause interval, for example, 1, 2, 3, 4, 5, 6, 7, 8, 9, 10, 15, or 20 minutes. Once the predetermined pause interval has elapsed, the camera apparatus 10 automatically begins recording. It should be appreciated that the user may also begin recording by actuating the pause button 46 again.

In the second mode, the camera apparatus 10 performs in much the same way as in the first mode. For example, in the second mode, the camera apparatus 10 records video in a recording loop for a predetermined duration, may be paused for a predetermined pause interval by actuating the pause button 46, and automatically begins recording again after the pause interval has expired. The second mode adds the ability to automatically save a recording when the camera apparatus 10 is turned off. Thus, if a user decides to turn the camera apparatus 10 off for privacy or the camera apparatus 10 is accidentally turned off, the recorded loop will automatically be saved, i.e. archived, to prevent the loss of important footage.

The third mode provides for automatic looping like that described in the first and second modes. In the third mode, the looping provides a recording loop (also referred to herein as a “buffer”) of a predetermined duration, for example, 1, 5, 10, 15, 20, 25, 30, 35, 40, 45, 50, 55, or 60 minutes. If an incident and/or event occurs, the user actuates the save button 52. Once the save button 52 is actuated, the camera 10 saves (i.e. archives) the buffer (e.g., previous 30 minutes of recorded footage) and starts a continuous recording—no loops. After the incident and/or event ceases to exist, the user actuates the save button 52 again, causing the camera apparatus 10 to save, i.e. archive, the continuous recording and start a new recording loop. Like the first and second modes, the pause button 46 provides the user with the ability to temporarily stop a recording loop for privacy during looping; however, once the camera apparatus 10 starts continuous recording, the pause button 46 will not work to pause the recording (i.e. the pause command would be ignored). If the save button 52 is actuated during a pause period, the camera 10 archives any data recorded in the buffer and starts continuous recording as described above.

When recording a video, the camera apparatus 10 uses sequence identifiers when creating files to be saved. The sequence identifiers provide an indication of which video files are associated with a single actuation of the save button 52. An example listing showing the sequence identifiers is shown below.
1. Camera powers on and runs for 10 minutes
   a. Files Created
      i. N00000000_20150505010029_1_0001.mp4
      ii. N00000000_20150505010129_1_0002.mp4
      iii. N00000000_20150505010229_1_0003.mp4
      iv. N00000000_20150505010329_1_0004.mp4
      v. N00000000_20150505010429_1_0005.mp4
      vi. N00000000_20150505010529_1_0006.mp4
      vii. N00000000_20150505010629_1_0007.mp4
      viii. N00000000_20150505010729_1_0008.mp4
      ix. N00000000_20150505010829_1_0009.mp4
      x. N00000000_20150505010929_1_0010.mp4
2. Save is pressed
3. Camera runs for 5 minutes
   a. New Files are created
      i. N00000000_20150505011029_2_0011.mp4
      ii. N00000000_20150505011129_2_0012.mp4
      iii. N00000000_20150505011229_2_0013.mp4
      iv. N00000000_20150505011329_2_0014.mp4
      v. N00000000_20150505011429_2_0015.mp4
4. Pause is pressed.
5. 10 minutes go by
6. Camera runs for 10 minutes
   a. New Files Created
      i. N00000000_20150505012429_2_0016.mp4
      ii. N00000000_20150505012529_2_0017.mp4
      iii. N00000000_20150505012629_2_0018.mp4
      iv. N00000000_20150505012729_2_0019.mp4
      v. N00000000_20150505012829_2_0020.mp4
      vi. N00000000_20150505012929_2_0021.mp4
      vii. N00000000_20150505013029_2_0022.mp4
      viii. N00000000_20150505013129_2_0023.mp4
      ix. N00000000_20150505013229_2_0024.mp4
      x. N00000000_20150505013329_2_0025.mp4
7. Save is pressed.
8. The camera continues recording for 50 more minutes
   a. New Files on The Camera
      i. N00000000_20150505003429_3_0026.mp4
      ii. N00000000_20150505003529_3_0027.mp4
      iii. . . . <sequence omitted for brevity>
      iv. N00000000_20150505012429_3_0076.mp4
9. The camera is connected to the computer via the USB cable and all of the files in the video folder are downloaded.

As shown above, the first set of files has an identifier of “1”. When the save button 52 is actuated, the next identifier “2” is attached to the new files; however, if the pause button 46 is actuated, the identifier “2” remains on the new files recorded after actuation of the pause button 46. When the save button 52 is actuated again, a new identifier “3” is attached to the new files. This process continues to allow users to differentiate the files.

The foregoing has described a camera apparatus and methods for its use. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends any novel one, or any novel combination, of the features disclosed in this specification (including any accompanying claims, abstract and drawings), or to any novel one, or any novel combination, of the steps of any method or process so disclosed.

What is claimed is:

1. A body camera apparatus, comprising:
an image sensor operable to generate image data;
a storage device operable to store the image data from the image sensor;
a controller operably connected to the image sensor and the storage device, the controller programmed to receive the image data and transfer the image data to the storage device in a recording loop of a predetermined duration;
wherein the controller is programmed to respond to a privacy command received from a user during the recording loop by pausing the transfer of image data to the storage device for a predetermined pause interval.

2. The apparatus of claim 1 wherein the controller is programmed to automatically resume the transfer of image data to the storage device after expiration of the pause interval.

3. The apparatus of claim 1 wherein the controller is programmed to respond to a save command received from a user during the recording loop by archiving the image data in the recording loop in the storage device, and starting a new recording loop.

4. The apparatus of claim 1 wherein the controller is programmed to respond to a power off command received from a user during the recording loop by archiving the image data in the recording loop in the storage device, prior to shutting off power to the apparatus.

5. The apparatus of claim 1 wherein the image sensor is sensitive to visible light and/or infrared light.

6. The apparatus of claim 5 further including at least one illuminating device.

7. The apparatus of claim 1 further including a display for playing back recorded image data.

8. The apparatus of claim 1 further including at least one microphone coupled to the controller and storage device for recording audio data.

9. The apparatus of claim 8 further including a speaker for playing back recorded audio data.

10. The apparatus of claim 1 further including at least one switch connected to the controller for inputting a user command to the controller.

11. A method of recording image data using a camera apparatus, comprising:
using an image sensor to generate image data;
transferring the image data to a storage device in a recording loop of a predetermined duration;
in response to a user save command, archiving the image data in the recording loop, and starting a new recording loop.

12. The method of claim 11 further comprising, in response to additional user save commands, repeating the steps of archiving image data and starting new recording loops.

13. The method of claim 11 further comprising:
in response to a user privacy command, pausing the transfer of image data to the storage device for a predetermined pause interval;
at the expiration of the pause interval, resuming the transfer of image data.

14. The method of claim 11 further comprising:
in response to a power off command received from a user during one of the recording loops, archiving the image data in the current recording loop in the storage device, prior to shutting off power to the image sensor.

15. The method of claim 11 wherein the image data is stored as a series of files, each file having a unique sequence identifier associated therewith.

16. The method of claim 15 wherein the unique sequence identifiers are incremented each time a save command is received from a user.

17. The method of claim 15 wherein the unique sequence identifiers are not incremented each time a privacy command is received from a user.

18. A method of recording video using a camera apparatus, comprising:
using an image sensor to generate image data;
transferring the image data to a storage device in a recording loop of a predetermined duration;
in response to a user save command, archiving the image data in the recording loop, and transferring image data from the image sensor to the storage device in a continuous recording.

19. The method of claim 18 further comprising in response to a subsequent save command, stopping the continuous recording, archiving the continuous recording and starting a new recording loop.

20. The method of claim 18 further comprising:
in response to a user privacy command, pausing the transfer of image data to the storage device for a predetermined pause interval;
at the expiration of the pause interval, resuming the transfer of image data.

21. The method of claim 20 further comprising ignoring any privacy commands received from a user during the continuous recording.
